(19) United States
(12) Patent Application Publication
(10) Pub. No.: US 2009/0319515 A1
(43) Pub. Date: Dec. 24, 2009

(54) SYSTEM AND METHOD FOR MANAGING ENTITY KNOWLEDGEBASES

(76) Inventors: Steven Minton, El Segundo, CA (US); Evan Gamble, Los Angeles, CA (US); Greg Barish, Redondo Beach, CA (US); Kane See, Los Angeles, CA (US)

Correspondence Address: CARR & FERRELL LLP, 2200 GENG ROAD, PALO ALTO, CA, 94303, US

(21) Appl. No.: 12/476,112

(22) Filed: Jun. 1, 2009

Related U.S. Application Data
(60) Provisional application No. 61/058,076, filed on Jun. 2, 2008.

(51) Int. Cl. G06F 7/10; G06F 17/30

(52) U.S. Cl. 707/5; 707/E17.014

(57) ABSTRACT

Systems and methods are presented for building comprehensive entity knowledgebases that can consolidate multiple linked references to the same entity. The resulting virtual repository can be efficiently queried. An incoming record is clustered into entities, which are collections of attributes. The system can determine the entity that most closely matches an incoming record. Coarse-grain representations (blocking) may be used initially to select a set of the most closely-matching entities, and then fine-grain representations (linkage) may be used. Coarse-grain and fine-grain match probabilities may be integrated to obtain integrated match probabilities between the record and each of the closest-matching entities. Entities are updated, including creating a new entity, merging two or more entities into one, dividing one entity, and making no change in the entities, after which the record is entered into the appropriate entity or entities. Embodiments support both free-form querying and document matching.

### PRIORITY CLAIM

The present application claims the priority benefit of U.S. provisional patent application No. 61/058,076 filed Jun. 2, 2008 and entitled “System and Method for Compiling, Organizing, and Querying Massive Entity Repositories,” the disclosure of which is incorporated herein by reference.

### GOVERNMENT INTERESTS

The research and development described in this application were supported by the Air Force Research Laboratory, Air Force Materiel Command, USAF, under Contract number FA8750-05-C-0116. The U.S. Government may have certain rights in the claimed inventions.

### BACKGROUND

1. Technical Field

The present invention generally relates to information management. More specifically, the present invention relates to compiling, organizing, and querying entity knowledgebases.

2. Background

Recent advances in networking technology, especially the Internet, have made a huge amount of data available about entities, such as people, places and organizations. Even so, ability to use the vast quantities of data online for identifying the references in text documents or linking information across sources remains primitive. Finding entities of interest in real time can be challenging, due to the difficulty of integrating and querying multiple databases, web sites, and document repositories.

Current approaches for linking information across sources, often called record linkage, require finding common attributes between the sources and comparing the records using those attributes. This often leads to unsatisfactory results because the sources are often missing information or contain incorrect or outdated information.

A record can comprise multiple attributes. Examples of attributes include: telephone number, a cellular phone number, a street number, a street name, a city, a state or province, a country, a postal or zip code, a street address, a first name, a last name, a company name, a person name, a job title, a facsimile number, an electronic mail address. A record can comprise multiple phone numbers, multiple addresses, multiple first names, and so on. An attribute may be broader than a key as the term is used in relational databases. For example, a name, address and phone number may be useful entity-identifying attributes, but none of them is a key.

Previous research on record linkage has developed a foundation for statistically linking references across multiple databases, referred to variously as record linkage, consolidation or object identification. Some work has been done regarding parallel record linkage and blocking techniques. However, these systems assume that the sources to be consolidated are tables in a relational database and do not address the issue of multi-valued attributes. Furthermore, these systems typically do not consider the issues of entity merging and dividing.

### SUMMARY OF THE PRESENTLY CLAIMED INVENTION

An embodiment manages a knowledgebase by receiving a record with one or more attributes. One or more entities within a data repository can be accessed, and a subset of the one or more entities that are a closest match to the received record can be identified. A match probability can be determined for each of the entities of the subset of the one or more entities with respect to the record. A modification can be selected for the subset of the one or more entities within the data repository. The modification can be based on the match probability and can incorporate at least a portion of the record.

A second embodiment is a computer-readable storage medium containing software that a computer can execute. Using the software, the computer can generate an entity-based data repository including representations of one or more entities. A data store accessible by the computer can receive a record. The computer can access entities in the data store and can determine a subset of entities that most closely match the record. The computer can calculate a match probability between each of the entities in the subset and the record. Using the match probability, the computer can determine how to modify the entities so as to best incorporate at least some of the record.

An embodiment can include a device for managing a knowledgebase which has memory, a processor and an entity management module. The entity management module is stored on the memory and executed by the processor. When executed, the entity management module can access a record having one or more attributes and received by the device. The module can identify a set of closest matching entities based on the received record and one or more attributes and determine a probability of match between the record and each entity of the set of closest matching entities. The module can update entity data within the plurality of entities based on the probability of match.

### BRIEF DESCRIPTION OF THE DRAWINGS

FIG. 1 illustrates an exemplary system for managing an entity knowledgebase.

FIG. 2A illustrates exemplary documents containing data to be incorporated into entities.

FIG. 2B is a table having exemplary entity data with multi-valued attributes.

FIG. 3A illustrates a block diagram illustrating exemplary data flow during a matching process.

FIG. 3B illustrates an exemplary geographic map comprising geographic regions.

FIG. 4 illustrates a flowchart of an exemplary computer-implemented method for managing entity knowledgebases.

FIG. 5 illustrates a flowchart of an exemplary computer-implemented method for identifying close matching entities.

FIG. 6 illustrates a flowchart of an exemplary computer-implemented method for determining match probability between a record and an entity.

FIG. 7 illustrates a flowchart of an exemplary process for updating entities.

FIG. 8 schematically illustrates components of a system for querying an entity knowledgebase.

FIG. 9 illustrates an example of a user query interface to the entity knowledgebase system.

FIG. 10 schematically illustrates components of a system for utilizing geospatial knowledge for identifying closest-matching entities.

FIG. 11 illustrates an exemplary computing system that may be used to implement an embodiment of the present invention.

### DETAILED DESCRIPTION OF THE INVENTION

The present technology discussed herein can rapidly create large-scale, well-organized entity knowledgebases. Entity knowledgebases integrate information on a scale that far exceeds current capabilities. An entity knowledgebase may comprise millions of entities. Entities can include collections of attributes and collectively form a high speed record recognition scheme. For example, an entity for a person may include one or more names for the person, addresses, phone numbers, and one or more other fields of data. The resulting entity knowledgebases can be used for a variety of applications (e.g., document understanding or data mining). The entity knowledgebase design represents a novel approach to integrating information from numerous heterogeneous sources.

An entity knowledgebase may consolidate data such that references to the same entity in multiple information sources may be resolved. The consolidation process can resolve references in different formats e.g., “Joe Smith” vs. “Smith, J. E.”, or “IBM” vs. “International Business Machines Corp.” In some embodiments, the consolidation process can also represent the current level of uncertainty regarding the best allocation of entities and records, can accommodate aliases, and can support continuous updates. Support for continuous updates can facilitate retention of information that may be revived when two previously consolidated references are later determined to refer to two distinct entities.

Entity knowledgebases may address fundamental representation issues. Since an entity knowledgebase may be constructed from multiple heterogeneous sources, it may be possible to support multi-valued attributes for describing an entity.

The entity knowledgebase architecture may consolidate multiple references to the same individual entity collected from different information sources. References can be statistically linked across multiple databases to build a practical architecture for large-scale information repositories. An integrated entity knowledgebase system can support the statistical consolidation process “invisibly” as an entity knowledgebase may be populated. The integrated entity knowledgebase system may enable users to easily understand and analyze results, enable queries to be executed efficiently, and be robust to updates so that references can be consolidated as new information becomes available.

Entity knowledgebases may also address the theoretical problems underlying virtual databases, i.e., mediator systems that integrate distributed, heterogeneous sources. Building large-scale virtual databases remains challenging in practice because it may be difficult to model complex data relationships and potentially expensive to execute arbitrary queries against virtual databases. Various specific problems may be addressed via the entity knowledgebase system. By focusing only on entities, the entity knowledgebase architecture simplifies the modeling issues and improves the tractability of query processing.

Most entities in the world are associated with a geospatial extent, which may be a point or a region. Embodiments of the present technology automatically determine an entity's geospatial extent and use this extent as an additional source of information for linking new sources of information into the system.

According to further embodiments, incoming records can stream to the system from users, systems or other sources through an application programming interface (API). According to some embodiments, records may be imported programmatically, may be entered through an input device, and may be imported from a database.

For example, if a new record is added to the system and the area code of the phone number indicates the record is in a particular region, then it may be less likely to be determined to match an entity located in a different region. Similarly, a new record having an area code located in the region where the entity is located may be more likely to be determined to match that entity.

When a record is added to an entity, then its company name attributes are added to the company name attributes of the entity, the record's person name attributes are added to the person name attributes of the entity, and so on.

An entity knowledgebase may be created and applied for just about any type of entity, including people, organizations, companies, terrorist groups, and so on. An entity knowledgebase could also be used to process data in a database or to reason about the relationships between entities (such as finding all organizations that are located in the same region and are mentioned in the same document).

The entity knowledgebase architecture may provide access to available information about entities from both local and remote sources. Even with the rapidly declining cost of storage, it may not be possible to store all relevant entity information in one location due to policy, control, and security considerations. In addition, data may be too volatile to store and may be accessed live when queried, such as the current stock price of a company. Therefore, the entity knowledgebase may be organized as a virtual repository that integrates both local data and remote data.

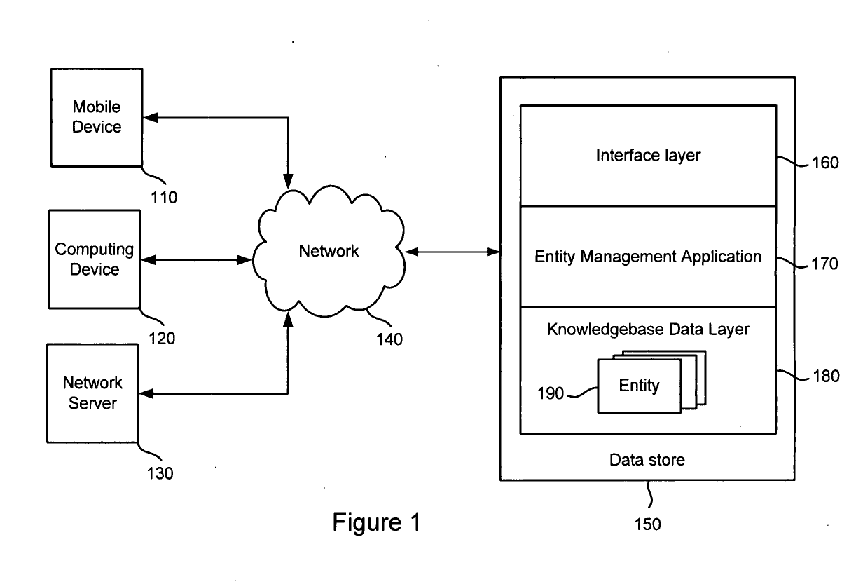

FIG. 1 illustrates an exemplary system for managing entity knowledgebases. The system as illustrated in FIG. 1 includes mobile device 110, computing device 120, network server 130, and data store 150. Mobile device 110 may be implemented as a mobile phone, laptop computer, notebook computer, personal digital assistant, or any other mobile device capable of communicating over network 140. The mobile device may “push” one or more records to data store 150 or provide data records to data store 150 in response to a request (e.g., as part of a data store record “pull”).

Computing device 120 can include a personal computer, workstation, or some other computing device. Computing device 120 can communicate with data store 140, including transmission of at least one record or query over a network 140 to data store 150 as part of a “pull” or “push” operation. Network server 130 can also communicate data with data store 150, including transmission of one or more records and queries.

Data store 150 may communicate with mobile device 110, computing device 120 and network server 130 over network 140. Data store 150 includes interface layer 160, entity management application 170 and knowledgebase data layer 180. Interface layer 160 may include one or more application programming interfaces (APIs), for example a query API for receiving and routing data queries and a new entity API for processing new entity data.

Entity management application 170 may be implemented as programs, software, code or other instructions stored in memory of data store 150 and configured executed by a processor. When executed, entity management application 170 may perform one or more methods to manage knowledgebase entities, for example to compile, organize, and query knowledgebase data layer 180, identify close-matching candidate entities, determine probability matches, and update entity data.

Knowledgebase data layer 180 may comprise data which can be queried by external or internal applications, modules and machines. The data can include one or more entities, entity matching data, record-entity probability matching data, and other data.

Network 140 is inclusive of any communication network such as the Internet, Wide Area Network (WAN), Local Area Network (LAN), intranet, extranet, private network, public network, mobile device networks, a combination of these networks, or other network.

The most general entity matching process that can be carried out pursuant to embodiments can be quite complicated and can involved detailed feedback between various evaluative levels. Moreover, the most general entity matching process that can be carried out pursuant to embodiments can be designed to properly handle numerous special cases that may be desirable for the most powerful entity knowledgebase and yet that may be rarely be encountered in practice, for example, when multiple entities have exactly the same match probability with a new record. For simplicity, and to most effectively illustrate the invention, examples are disclosed below of the matching process pursuant to embodiments.

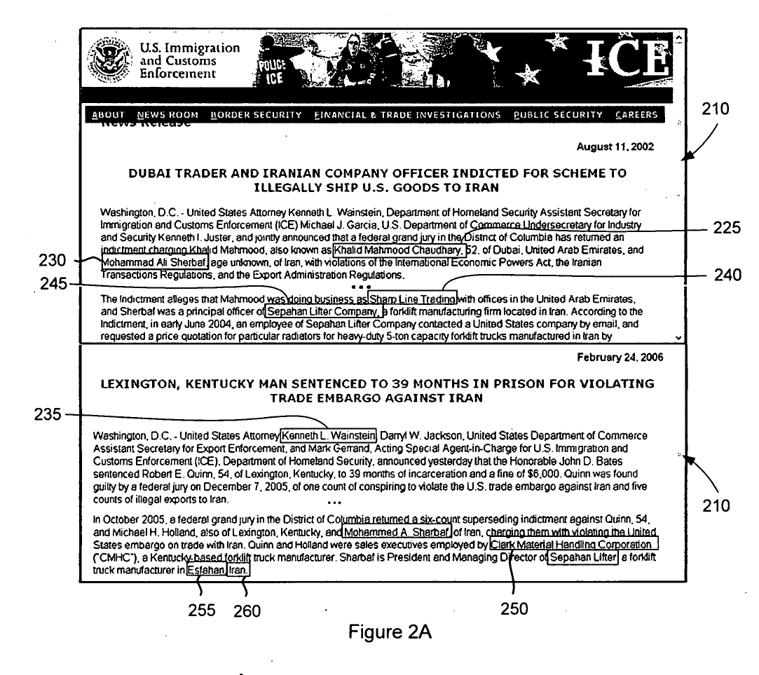

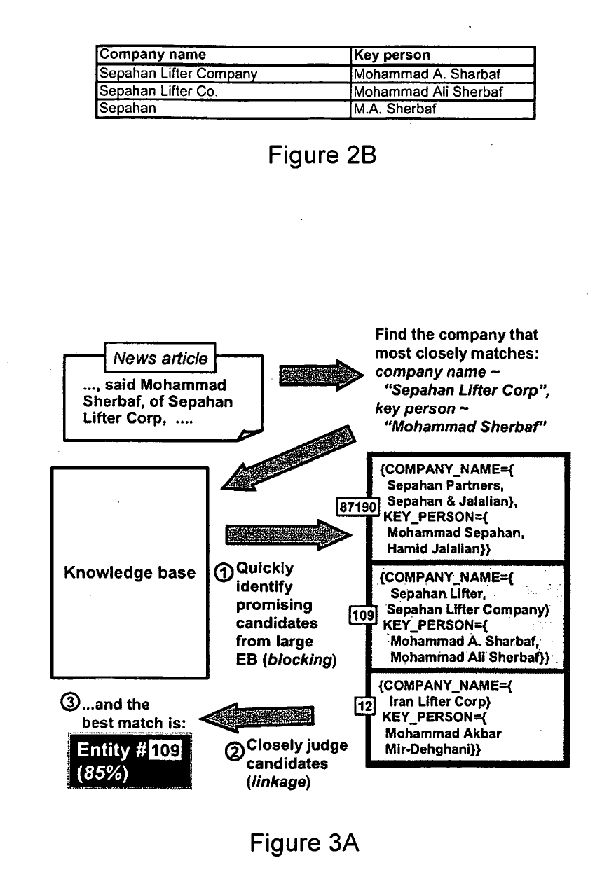

FIG. 2A illustrates exemplary documents containing data to be incorporated into entities. The documents include extracts of two news releases 210 and 220. The news releases 210 and 220 were issued by the U.S. Immigration and Customs Enforcement, an agency of the U.S Department of Homeland Security. The news releases 210 and 220 describe a case involving several individuals and companies accused of illegal exports to Iran.

The documents include information that a party may be interested in parsing and storing. Entity extraction software can extract data from the documents 210 and 220, such that the data can be included in an entity. The extracted data may be associated with a company, personal or location name, and other data. For example, item 225, “Khalid Mahmood Chaudhary,” item 230, “Mohammad Ali Sherbaf,” and item 235, “Kenneth L. Wainstein” may be recognized as person names. Similarly, item 240, “Sharp Line Trading,” item 245, “Sepahan Lifter Company,” and item 250, “Clark Material Handling Corporation” may be labeled as companies. Similarly, item 255, “Esfahan,” may be labeled as a city and item 260, “Iran,” may be labeled as a country.

However, simple entity extraction may not establish a potential relationship between data in the two documents. Entity knowledgebases provide record linkage reasoning that resolves the shortcoming of previous technology. In this example, even though the documents originate from the same government agency, the 2002 document 210 refers to one of the key persons involved in the case as “Mohammad Ali Sherbaf” while the 2006 document 220 refers to one of the key persons as “Mohammad A. Sharbaf.” Different transliterations of foreign names may foil simple match techniques. The multiplicity of names that refer to the same real-world entity may not be limited to people—other entities, such as companies and locations, may exhibit the same phenomenon. For example, both “Isfahan” and “Esfahan” are common transliterations for the same Iranian city.

As appropriate, the entity knowledgebase may use previously gathered knowledge to help differentiate or help consolidate the entities that appear in documents like these and to provide additional information regarding these documents. The present technology may recognize that “Mohammad Ali Sherbaf” and “Mohammad A. Sharbaf” are the same person and that “Sepahan Lifter Company”, “Sepahan Lifter”, “Sepahan Lifter Co.” refer to the same company. Moreover, the entity knowledgebase also may show that this company has its headquarters in “Nos. 27 and 29, Malekian Alley, North Iranshahr Ave., Tehran (15847)” and its factory in “Mahyaran Industrial Town, Isfahan”; that its commercial manager is “Mohammad Kharazi” and its headquarters' phone and fax numbers are, respectively, (+98-21) 8830360-1 and (+98-21) 8839643. At the same time, the entity knowledgebase may show that “Sepahan Lifter Company”, “Behsazan Granite Sepahan Co.”, or “Rahgostar Nakhostin Sepahan Co.” are different companies that are all located in Isfahan, Iran.

In order to maximize effective representation of entities, the multi-valued nature of entity information can be efficiently depicted by an entity knowledgebase. For example, a company may have multiple phone numbers or multiple addresses. Many people are known by multiple names, e.g., maiden name and married name. Many publications have multiple authors. This complicates the issue of record linkage, because the data may not be a simple record but an object with multi-valued attributes.

This feature of real world entities requires a more general representation than the traditional records. As a more detailed example, FIG. 2B is a table having exemplary entity data with multi-valued attributes.

An entity can be represented as a set of set-valued attributes. For example, as shown in FIG. 2B, a company name for one of the companies discussed in FIG. 2A can be represented as item, “Sepahan Lifter Company,” item, “Sepahan Lifter Co.,” or item, “Sepahan.” Similarly, a key person for this company can be represented as item, “Sepahan Lifter Company,” item, “Sepahan Lifter Co.,” or item, “Sepahan.” Multi-valued attribute representation may reduce the amount of data to be stored to only the unique attribute values, but may require more sophisticated matching techniques. Embodiments may help resolve these difficulties by supporting entity linkage in addition to record linkage.

The present technology can also represent entity attributes at different levels of granularity. This issue may arise due to the heterogeneous origins of the data and the inability to precisely parse all types of real-world information. Data in the entity knowledgebase can comes from different sources that have different representation schemas. For example, one source may break down address into street, city, state, country, and postal code, while another may just have all of this data in one attribute (e.g., address).

According to embodiments, an entity knowledgebase maximizes effective representation of entities by incorporating the level of schema granularity. Normalizing information into finer levels of granularity—while seemingly more precise—may not always be possible and may potentially result in a loss of information. According to embodiments, the entity knowledgebase can account for this fact. A user may decide the level of granularity the entity knowledgebase will use to normalize the information. Generally speaking, there may be at least two possible options: fine-grain or coarse-grain. These two options can be combined and integrated in various ways according to embodiments.

According to embodiments, the fine-grain option permits the capture of attributes such as street, city, state, suite number, and postal code, provides more information about a match. For example, the fine-grain option may identify the specific attribute that matches. At the same time, this option assumes that all information can be neatly deconstructed, or that it is possible to store ambiguous information when information cannot be reliably parsed.

A name or an address may be parsed into low-level fields or tokens. For example, consider the sequence of tokens “Mohammad Ali Sherbaf”. The fine-grain option may assume that we can parse this name, in particular that we know the first name is “Mohammad” and that the last name is either “Ali Sherbaf” or that the middle name is “Ali” and the last name is “Sherbaf”.

The coarse-grain option, on the other hand, may not identify the specific attribute that matches, but may eliminate the need to unambiguously parse the data. If the data is treated as a sequence of tokens, i.e., a document, there may be no need to resolve ambiguous parses when storing the data. However, this may mean that the data must later be parsed at run-time or “on the fly,” possibly producing sub-optimal performance.

Embodiments offer a hybrid approach that exploits advantages of both the coarse and fine-grain representation. The coarse-grain representation, also known as blocking, may be used during the initial phase of generating candidate matches since this initial matching is based on token overlap. A coarse-grain match probability may be calculated between the record and at least two of the entities that best match the record. This is discussed in more detail below.

Both the coarse-grain and fine-grain representations are available for reasoning in the detailed matching process. Blocking may be efficient, relying as it does on simpler (e.g., token-based) metrics to identify a set of candidate entities. In contrast, the linkage phase may focus on accuracy, performing a more careful analysis of each candidate entity, including evaluation of the parsed data.

An entity knowledgebase may provide at least two main capabilities: (1) entity matching, that is, the ability to match the relevant entities given a query, and (2) entity creation/update, that is, the ability to decide whether newly acquired information belongs to an existing entity or constitutes a new entity. In some cases, entity creation or update may necessitate a matching routine.

If an incoming record is a query, no new data is provided. An incoming data record may result in the insertion of new data. According to embodiments, such new information may cause the computer to re-evaluate the configuration and contours of some or all of the current entities.

Blocking and linkage complement each other, with the former focusing on performance and the latter focusing on quality. It may be advisable to ensure that the efficiency of blocking does not result in false negatives, and that the blocking phase does not produce too many false positives.

Embodiments may concatenate and de-convolve contours of entities to align data with the fields in the entity. Then the adjusted fields of the entity may be compared to the corresponding fields in the cluster. The process may be reiterated any number of times.

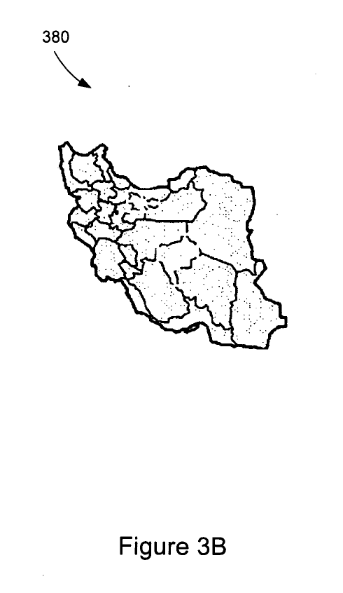

FIG. 3A illustrates a block diagram illustrating exemplary data flow during a matching process. An incoming news document mentions the company “Sepahan Lifter Corp” as well as “Mohammad Sherbaf”. This information may be used to query the data store 150, which can include millions of company entities. The blocking process efficiently identifies candidates that appear consistent with the information that is known. As the example shows, many of the candidates can have tokens that also appear in the query. Any of several matching techniques can be used to identify candidates, such as applying a Jaccard-style metric (i.e., token overlap) or TF-IDF would be sufficient to yield the candidates shown.

The linkage process then may compare the data in greater detail, parsing the incoming query to realize that “Corp” is a previously unseen term associated with the company's name, and that “Ali” is missing from Mohammad Sherbaf's name. It also may evaluate the other candidates and identifies similar differences. In evaluating the candidates, the linkage phase associates metric scores to quantify the similarity (or lack thereof). A second part of the linkage process may evaluate the similarities/dissimilarities and then judge the implications of such scores. For example, the linkage process could have identified that Corp is just a common company formation acronym (like “Inc.” or “LLP”) and that the missing “Ali” from the person's name is not critical (as opposed to a mismatch on last name, for example).

New data may cause two previously distinct entities to merge. Typically, the merging scenario arises when new information contains strong matches to two different entities. For example, in FIG. 3A, entity #12 (Iran Lifter Corp) is different from entity #109 (Sepahan Lifter Company). However, the knowledge database of data store 150 can be updated with a new source of Iran company information and that one of those incoming records suggests that Mohammad Akbar Mir-Dehghani is a key person of Sepahan Lifter. The entity match phase would then result in both entity #12 and entity #109 receiving high match confidences. At that point, the logic of data store 150 may decide to merge those two entities together. This is described in more detail below.

Where necessary, by exploiting the geospatial extents of these entities, the system can deduce additional information to narrow down the number of relevant entities. For example, FIG. 3B illustrates an exemplary geographic map of Iran 380 comprising geographic regions likely to be matched with different candidate entities. It may be known that the company 315 mentioned in the document may be located within a map of Iran 380 depicted in FIG. 3B. It may be further known that the company is located within an area 390. The system may infer, based on an associated telephone number attribute, that entity 355 may be located within area 390. The system may infer, based on the associated telephone number attributes, that entities 360 and 365 are located within an area 395 of the map of Iran 380. This result may imply, compared to a relatively high similarity between the company 315 mentioned in the document and entity 355, lower similarity between the company 315 mentioned in the document and the two entities 360 and 365.

Identifying the exact geospatial extent of an entity may not necessarily be a straightforward process. A record's textual geographic information (e.g., mailing addresses) may be transformed to spatial geocoordinates. Geocoordinates of a company may be determined using a geocoder with the mailing address as input. Typically, a geocoder determines the geocoordinates of an address by utilizing a comprehensive spatial database (e.g., a labeled road network data). However, such a comprehensive, well-formatted spatial database may not exist or may not be accessible for many countries. Additionally, addresses may be non-standard (e.g., “No. 1780, Opp. to The Main Gate of England Embassy Garden, Off the Dolat St., Shariati Ave., Tehran, Iran”), incomplete, and sometimes even non-existent for a given record (e.g., only the phone number exists).

Entity knowledgebase 150 ultimately determines that with an 85% probability, the best-matching entity is entity 360. Entities are modified accordingly and the record is stored accordingly. The user is notified as appropriate.

Accordingly, various techniques may be used to build a geospatial knowledgebase of an area from available public data. The geospatial knowledgebase may contain abundant inferred spatial datasets, such as landmarks, road network data, zip code maps, and area code maps. For example, area code data for Iran may not be available. Area code regions may be approximated and stored in the geospatial knowledgebase. Embodiments may build approximate thematic maps (e.g., area code maps), utilizing classification techniques such as Support Vector Machines based on a set of training data. For example, the training data can be cities with spatial coordinates and area code attributes. Spatial classification of the training data (geocoordinates labeled with area code) may produce an approximate thematic map of the area code regions.

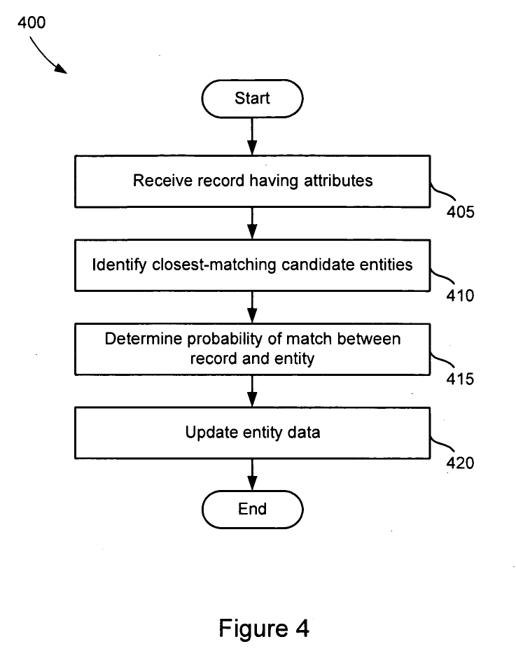

FIG. 4 illustrates a flowchart of an exemplary method for managing entity knowledgebases. In step 405, a record having one or more attributes is received. The record can be received at the beginning of the method or at any other time. The record can be received by a computer, such as data store 150, over network 140, for example as a data stream, and include a record having one or more attributes. Receipt of the record can initiate a document matching query in which a document is received comprising partial entity information and additional entity information is requested. The partial entity information triggers the computer to perform an entity matching process that may comprise extracting information from the document.

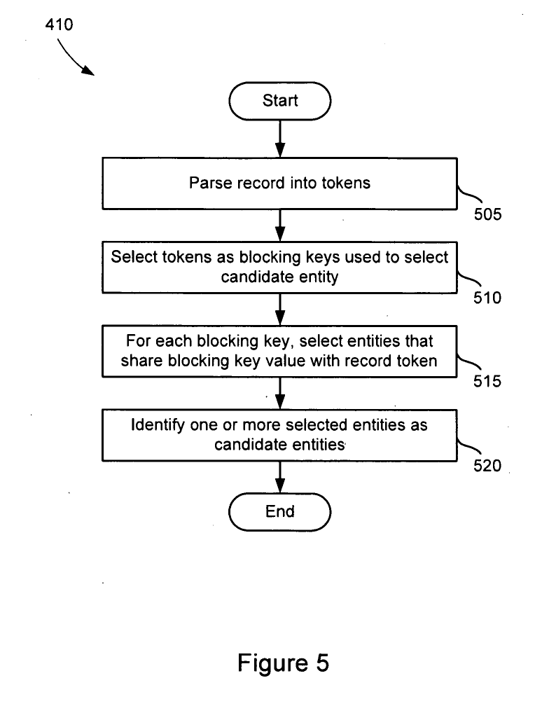

The closest matching candidate entries are identified at step 410. The closest matching candidate entries can include the existing data store entities which are determined to be the closest matches to the received record. Data store entities that are not determined to closely match the received record are “blocked” from being identified or further processed with respect to the received record. Identifying the closest matching candidate entries is discussed in more detail below in FIG. 5.

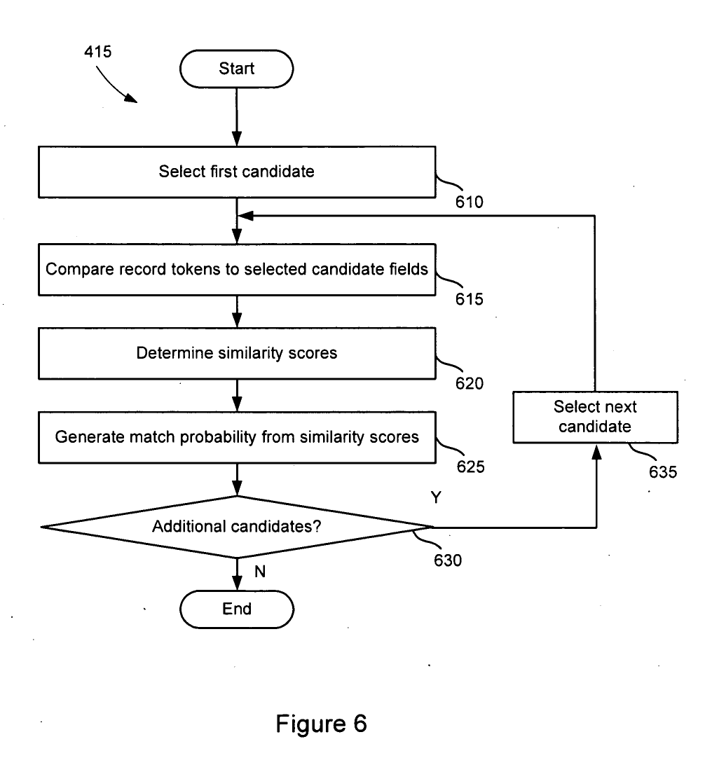

In step 415, the computer determines a probability of a match between the record and one or more of the closest-matching entities. Determining the probability of match can be performed based on a comparison of record tokens to selected candidate fields. The determined probabilities can be considered “match probabilities.” Determining the probability of match between a record and an entity is discussed in more detail below with respect to FIG. 6.

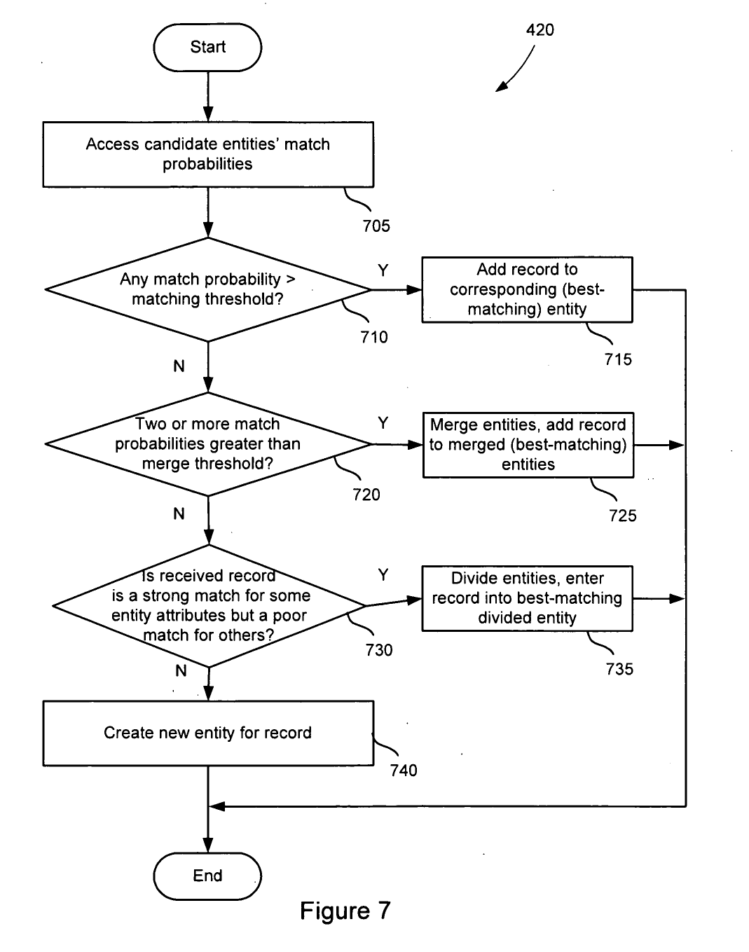

Entity data is updated at step 420. The entity data can be updated based on the match probabilities determined at step 415. Entity updates can involve creating a new entity, merging two or more entities into fewer entities, and dividing an entity into two or more entities. This may be particularly appropriate when some attributes in the record are close to the entity and others are not, i.e., when there is a high match probability for some attributes and a low match probability for other attributes. Subsequently, the computer enters the record into the appropriate entity or entities. Updating entity data is discussed in more detail with respect to FIG. 7.

FIG. 5 illustrates a flowchart of an exemplary computer-implemented method for identifying close matching entities. The method of FIG. 5 can provide more detail for step 410 of the method of FIG. 4.

A received record is parsed into tokens at step 505. The record can be parsed by entity management application 170. For example, an incoming record that includes a company name of “Sepahan Lifter Corp” will have that company name portion of the record divided into tokens of “Sepahan”, “Lifter” and “Corp.”

Tokens are selected which are to be used to select candidate entities at step 510. Application 170 may select one or more of the generated tokens to select candidate entities which include attributes that correspond to the tokens. The tokens may be selected based on the field category or name, based on the number of tokens per record field, or chosen in some other manner. In some embodiments, application 170 can select one or more tokens that, for purposes of the received record, are required to be present in a candidate entity.

In step 515, entity management application 170 selects entities having an attribute that matches the selected tokens of the received record. A candidate entity can have attributes that matches each selected token, a single token, or some other number of tokes. By only selecting entities with attributes that match the token, the selected token can serve as a “blocking key” by blocking entities which do not have attributes that correspond to or match the token.

One or more selected entities are identified as candidate entities at step 525. Each selected entity may be associated with a matching value. Candidate entities may be selected based on the highest set number of entities (e.g., the top five entities), all entities that match a certain number of record attributes, or some other metric. The resulting candidate entities are also known as closest-matching entities.

The “blocking phase” as discussed with respect to the method of FIG. 5 is to very quickly identify the most promising candidates from a much larger set of possible candidates. Blocking may rely on simple yet efficient techniques for reducing the space of possible candidates, for example by using token-based distance metrics (Jaccard similarity coefficients, term frequency-inverse document frequency [TF-IDF], etc).

FIG. 6 illustrates a flowchart of an exemplary computer-implemented method for determining match probability between a record and an entity. The method of FIG. 6 can be performed by entity management application 170 and provides more detail step 415 of the method of FIG. 4.

A first candidate entity is selected at step 610. The first candidate entity is one of the identified candidate entities or closest-matching entity discussed with respect to FIG. 5. Record tokens are compared to selected candidate fields at step 615. The comparison is generally a single element comparison.

Similarity scores are generated at step 620. The similarity scores are generated by expressing the results of these comparisons at step 615. The more closely the record token and candidate field match, the higher the similarity score.

A match probability score is generated from the similarity scores at step 625. The In step 625, the computer uses the similarity scores to generate a match probability expressing the probability of a match between the candidate entity and the record. Generating the match probability may be accomplished through a variety of more sophisticated transformations (e.g., alignment of parsed representations of the data), which can be more accurate but which may require more computational resources. In step 630, a determination is made as to whether additional candidates exist to be selected. If there are additional candidates to select, the next candidate is selected at step 635 and operation of the flow chart returns to step 615. If no additional candidates exist to process, the method of FIG. 7 ends.

FIG. 7 illustrates a flowchart of an exemplary process 420 for updating entities after a new record is received. The method of FIG. 7 can be performed by entity management application 170 and provides more detail for step 420 of the method of FIG. 4. In some embodiment, the method of FIG. 7 can be performed for each record received by data store 150.

In step 705, the entity updating process starts with a computer accessing match probabilities for candidate entities selecting a first candidate entity. For example, these match probabilities can be obtained through a process such as that illustrated in FIG. 6.

A determination is made as to whether any match probability between a candidate entity and the received record is greater than a matching threshold at step 710. For example, if the matching threshold is 99%, a candidate entity with a match probability of 99% would satisfy the determination. Matching threshold can be set automatically based on past results, received from a user, or in some way. Alternatively, a matching threshold may be preset as an initial condition.

If the match probability satisfies the matching threshold, the record data (e.g., field data) is added to the corresponding best-matching entity at step 715. For example, record data comprising a company name would be added to the entity attribute associated with company name, as long as the information was not matching and would result in duplicate data in an attribute.

If the match probability is less than or otherwise does not satisfy the matching threshold, then a determination is made as to whether two or more match probabilities are greater than a merge threshold at step 720. For example, if the merge threshold is 80%, then two or more entities must have a match probability of greater than 80% to satisfy the merge threshold. If less than two match probabilities are greater than the merge threshold, then the entities are not merged at step 725 and the method continues to step 730.

If any two match probabilities are greater than the merge threshold, then the entities are merged at step 725 and the received record is added to the merged entity. Merging can be performed when new information contains strong matches to two different entities. For example, in FIG. 3A, entity 365 (Iran Lifter Corp) is depicted as different from entity 360 (Sepahan Lifter Company). However, the entity management application 170 may, for example, receive a new data record comprising Iran company information that suggests that Mohammad Akbar Mir-Dehghani may be a key person of Sepahan Lifter. In that case, the entity match phase results in both entity 360 and entity 365 receiving high match confidences. At that point, application 170 may merge the entities together.

A determination is made as to whether the received record is a strong match for some entity attributes and a poor match for other entity attributes at step 730. An entity having attributes that matches well with some record data (tokens) but not others can indicate that the entity with mixed strength in matching should be split. If so, the existing entity is split or divided at step 735 into a first entity that includes the attributes that match the record data and a second entity that includes the entity attributes that do not match the record data. The record data may then be placed into one or both of the first entity and second entity. In some embodiments, each record token can be placed into one of the newly created entities for which it matches an entity attribute.

If the received record is not a strong match for any entity attributes, a new entity is created at step 740 and the record is entered into the new entity. In this step, it has been determined that the received record is not a strong match with any entity, and that a new entity will be created for the received record.

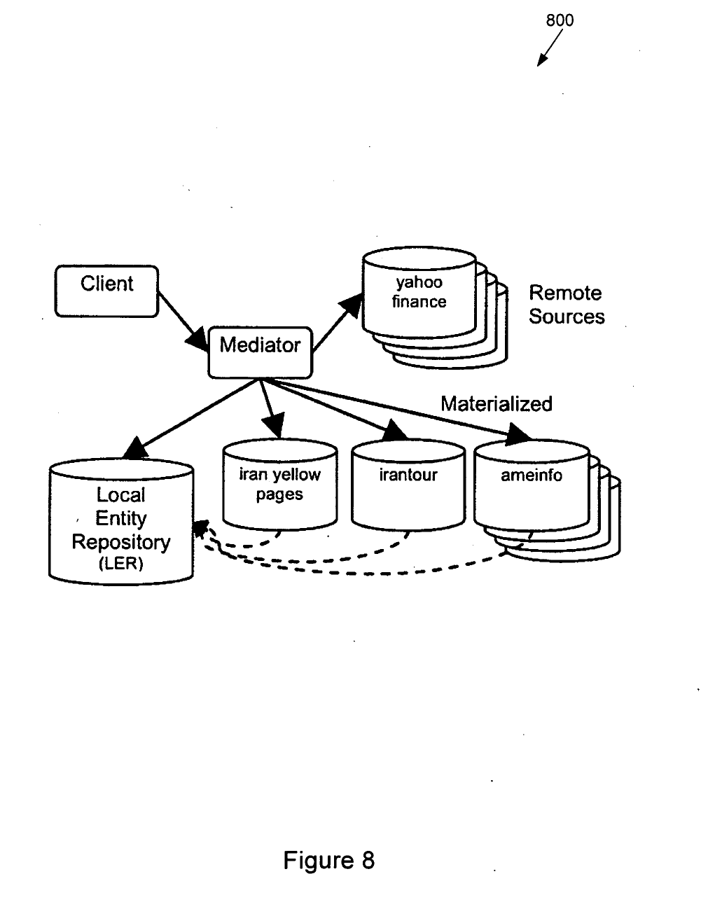

FIG. 8 schematically illustrates components of a system for querying an entity knowledgebase. A Local Entity Repository (LER) stores identifying attributes of the entities in order to promote efficient record linkage by the system. Additional materialized entity-related information may also be stored, but to enhance performance, it may not be copied into the LER. Examples of additional materialized (local) entity-related information include Iranian yellow page directory information, Iranian tourism information, American-sourced information, and other materialized entity-related information. For example, images and reports may be associated with entities, but they may not be useful for efficient record linkage. Finally, the system may store as remote sources other information such as, for example, Yahoo-sourced financial information.

The system may use a mediator to orchestrate all these local and remote sources. A mediator may use a mediated schema to assign common semantics to the data from the diverse sources. This may allow a human client or a client program to query the entity knowledgebase using the mediated schema without worrying about how the information may be represented in the sources.

An entity knowledgebase mediator may handle both types of queries (free-form querying and document matching) similarly. First, the mediator invokes the entity matching module with the constraints appearing in the query. In free-form querying, the constraints are the selections on entity-identifying attributes appearing in the query. In document matching, the partial entity information triggers entity matching. Next, the mediator retrieves the requested information from materialized (local) sources or from remote sources corresponding to the set of candidate entities produced by the entity matching module.

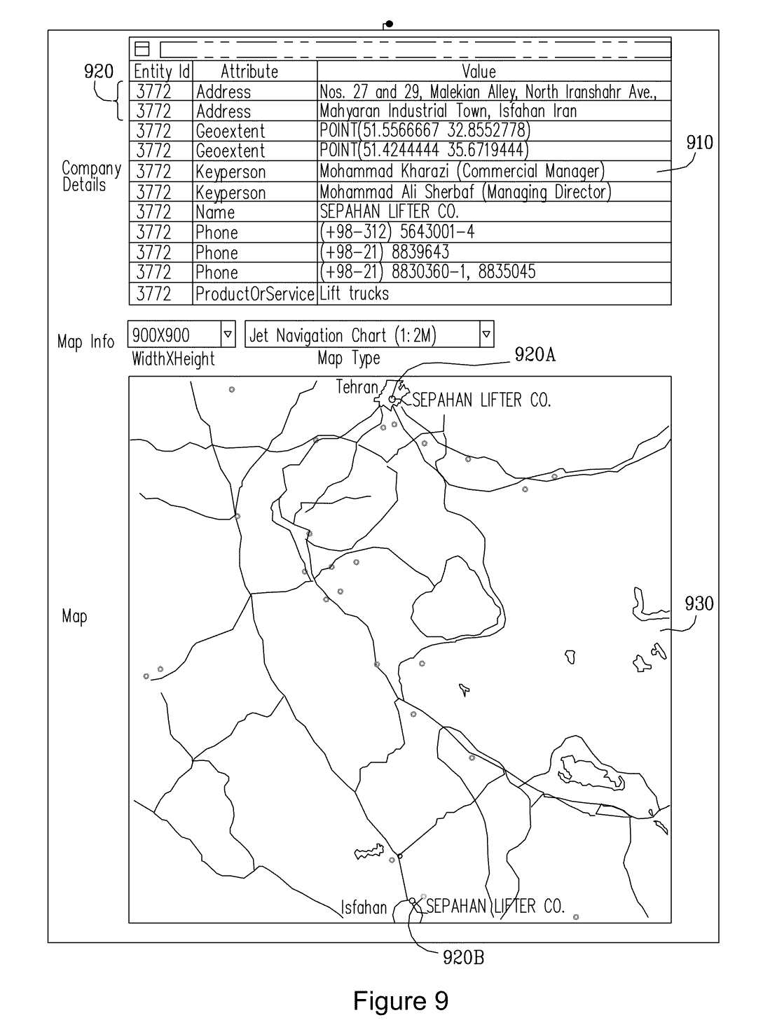

FIG. 9 illustrates an example of a user query interface 900 to the entity knowledgebase system. Detailed data 910 regarding the Sepahan Lifter Company includes geospatial locations. The company has two addresses 920, one address 920A in Teheran and one address 920B in Isfahan. The map 930 shows these two locations.

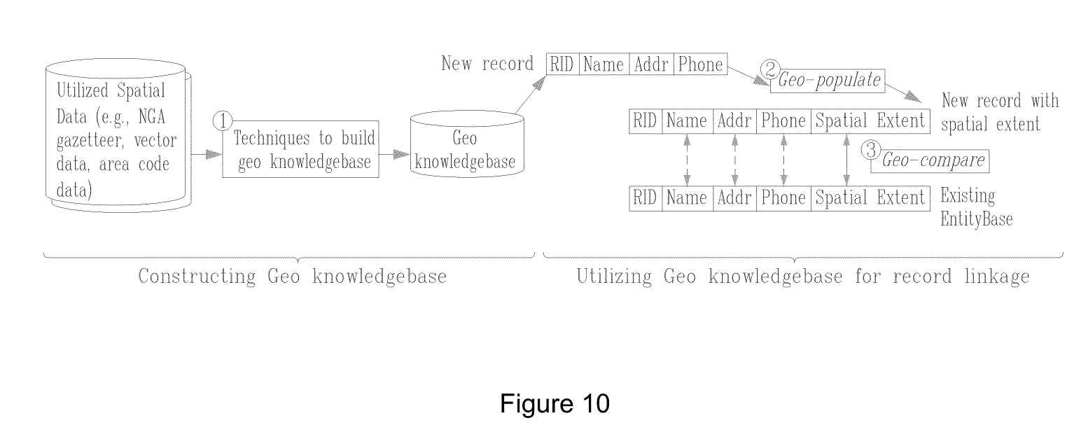

FIG. 10 schematically illustrates components of a system 1000 for utilizing geospatial knowledge for identifying closest-matching entities 355, 360, and 365 (not pictured).

There may be many online public data sources 1010 capable of providing coordinates of populated points, including cities, around the world. One example is the National Geospatial-Intelligence Agency (NGA) gazetteer database (http://earth-info.nga.mil/gns/html/index.html) 1010. Embodiments may use techniques 1020 to build a geospatial knowledgebase 1030. Geospatial knowledgebase 1030 may comprise thematic maps using three datasets 1010 collected for Iran: (1) Iran area codes and corresponding cities, which are available from IranAtom (http://iranatom.ru); (2) the NGA Gazetteer database; and (3) Iran province information that provides the spatial bounding box for every province in Iran. Approximate area code vector maps generated according to embodiments may then be stored into the geospatial knowledgebase 1030 using, for example, Oracle 10 g.

A new record 1040 arrives. New record 1040 comprises, for example, a record identification number (RID) 1045, a name 1050, an address 1055, and a phone number 1060. A geo-populate function 1065 analyzes the phone number 1060 of new record 1040 to obtain its area code. The geo-populate function 1065 then queries geospatial knowledgebase 1030 with the given area code to discover the spatial extents 1070 (a point or a region) for the record 1040. To utilize the geospatial knowledgebase 1030 for comparing entities 355, 360, and 365 (not pictured) based on their geocoordinates 1055, the system may assign its best estimate 1070 of a spatial extent to new incoming record 1040. The system may support efficient comparisons between entities based on their respective assigned spatial extents 390 (or 395). Two functions may assist with this process, the geo-populate function 1065 and a geo-compare function 1075. The geo-compare function 1075 then utilizes Oracle spatial APIs to compute how close the spatial extent of new record 1040 is to the spatial extent of the closest-matching entities 355, 360, and 365 (not pictured) stored in entity knowledgebase 150 (not pictured). This is done by comparing attributes of closest-matching entities 355, 360, and 365 (not pictured) with the corresponding attributes of record 1040. Thus RID 1080 of closest-matching entities 355, 360, and 365 (not pictured) may be compared with RID 1045 of record 1040. Similar comparisons may be made between record name 1050 and entity name 1085, between record address 1055 and entity address 1090, and between record phone number name 1060 and entity phone number 1095.

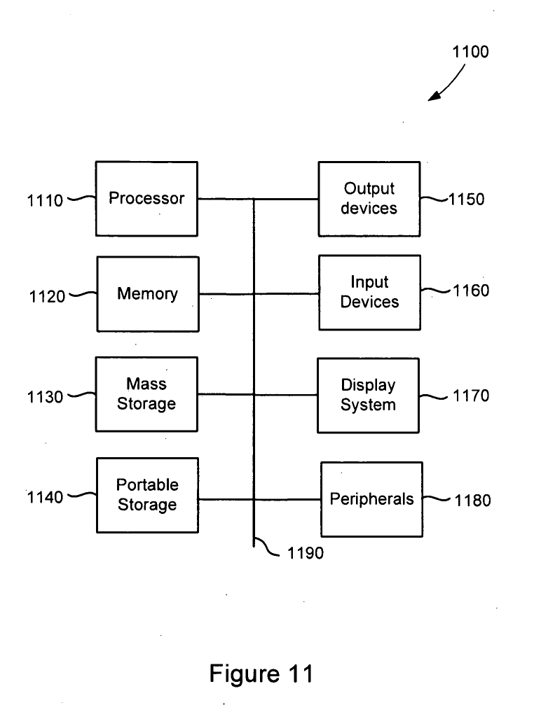

FIG. 11 illustrates an exemplary computing system 1100 that may be used to implement an embodiment of the present invention. System 1100 of FIG. 11 may be implemented in the contexts of the likes of mobile device 110 (not pictured), computing device 120 (not pictured), network server 130 (not pictured), and entity knowledgebase 150 (not pictured). The computing system 1100 of FIG. 11 includes one or more processors 1110 and main memory 1120. Main memory 1120 stores, in part, instructions and data for execution by processor 1110. Main memory 1120 can store the executable code when in operation. The system 1100 of FIG. 11 further includes a mass storage device 1130, portable storage medium drive(s) 1140, output devices 1150, user input devices 1160, a graphics display 1170, and peripheral devices 1180.

The components shown in FIG. 11 are depicted as being connected via a single bus 1190. The components may be connected through one or more data transport means. Processor unit 1110 and main memory 1120 may be connected via a local microprocessor bus, and the mass storage device 1130, peripheral device(s) 1180, portable storage device 1140, and display system 1170 may be connected via one or more input/output (I/O) buses.

Mass storage device 1130, which may be implemented with a magnetic disk drive or an optical disk drive, is a non-volatile storage device for storing data and instructions for use by processor unit 1110. Mass storage device 1130 can store the system software for implementing embodiments of the present invention for purposes of loading that software into main memory 1120.

Portable storage device 1140 operates in conjunction with a portable non-volatile storage medium, such as a floppy disk, compact disk or Digital video disc, to input and output data and code to and from the computer system 1100 of FIG. 11. The system software for implementing embodiments of the present invention may be stored on such a portable medium and input to the computer system 1100 via the portable storage device 1140.

Input devices 1160 provide a portion of a user interface. Input devices 1160 may include an alpha-numeric keypad, such as a keyboard, for inputting alpha-numeric and other information, or a pointing device, such as a mouse, a trackball, stylus, or cursor direction keys. Additionally, the system 1100 as shown in FIG. 11 includes output devices 1150. Suitable output devices include speakers, printers, network interfaces, and monitors.

Display system 1170 may include a liquid crystal display (LCD) or other suitable display device. Display system 1170 receives textual and graphical information, and processes the information for output to the display device.

Peripherals 1180 may include any type of computer support device to add additional functionality to the computer system. Peripheral device(s) 1180 may include a modem or a router.

The components contained in the computer system 1100 of FIG. 11 are those typically found in computer systems that may be suitable for use with embodiments of the present invention and are intended to represent a broad category of such computer components that are well known in the art. Thus, the computer system 1100 of FIG. 11 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The above description is illustrative and not restrictive. Many variations will become apparent to those of skill in the art upon review of this disclosure. The scope should, therefore, be determined not with reference to the above description, but instead should be determined with reference to the appended claims along with their full scope of equivalents.

1. A computer implemented method for managing a knowledgebase, comprising:
receiving a record by a data store;
accessing one or more entities within the data store and identifying a subset of the one or more entities that are a closest match to the received record;
determining a match probability for each of the subset of the one or more entities with respect to the record; and
selecting a modification for the subset of the one or more entities within the data repository based on the match probability, the modification incorporating at least a portion of the record.

2. The method of claim 1, wherein the modification involves the closest-matching entity.

3. The method of claim 1, wherein the modification comprises adding the record to the closest-matching entity.

4. The method of claim 1, further including receiving a matching threshold from a user.

5. The method of claim 1, wherein selecting a modification includes dividing the entity into two or more entities if the entity attributes match some record data and does not exceed the matching threshold for other attributes.

6. The method of claim 1, wherein the modification comprises merging two or more entities into merged entity.

7. The method of claim 1, wherein the modification comprises dividing an entity into two or more new entities.

8. The method of claim 1, wherein determining a subset of one or more entities comprises:
selecting one or more tokens from the received record; and
identifying one or more entities based on the selected tokens.

9. The method of claim 8, wherein identifying a match probability includes:
generating a match probability from the record tokens and the entity candidate fields.

10. The method of claim 9, wherein generating a match probability includes determining similarity scores in response to a comparison between record tokens and selected candidate fields.

11. The method of claim 9, wherein selecting one or more tokens includes selecting a token based on the number of tokens in a field of the record.

12. The method of claim 10, wherein the modification comprises adding the record to the entity for which the record has the highest integrated match probability.

13. A computer readable storage medium having embodied thereon a program, the program being executable by a processor to perform a method for managing a knowledgebase, the method comprising:
receiving a record by a data store;
accessing one or more entities within the data store and identifying a subset of the one or more entities that are a closest match to the received record;
determining a match probability for each of the subset of the one or more entities with respect to the record; and
selecting a modification for the subset of the one or more entities within the data repository based on the match probability, the modification incorporating at least a portion of the record.

14. The computer readable storage medium of claim 13, wherein identifying a subset of one or more entities comprises:
selecting one or more tokens from the received record; and
identifying one or more entities based on the selected tokens.

15. The computer readable storage medium of claim 13, wherein the modification involves the closest-matching entity.

16. The computer readable storage medium of claim 13 wherein the modification comprises adding the record to the closest-matching entity.

17. The computer readable storage medium of claim 13, wherein selecting a modification includes dividing the entity into two or more entities if the entity attributes match some record data and does not exceed the matching threshold for other attributes.

18. A device for managing a knowledgebase, comprising:
memory configured to store programs and a plurality of entities having one or more attributes;
a processor coupled to the memory and configured to execute programs stored on the memory; and
an entity management module stored in memory and configured to be executed by the processor, the entity management module able to access a record having one or more attributes and received by the device, identify a set of closest matching entities based on the received record and one or more attributes, determine a probability of match between the record and each entity of the set of closest matching entities, and update entity data within the plurality of entities based on the probability of match.

19. The device of claim 18, wherein the entity management module is able to parse the record into one or more tokens, the closest matching entities determined based on the record tokens and the entity attributes.

20. The device of claim 19, wherein the entity management module is configured to update entity data within the plurality of entities by merging two or more entities and dividing an entity into multiple entities.
